(19) United States
(12) Patent Application Publication
(10) Pub. No.: US 2025/0321868 A1
(43) Pub. Date: Oct. 16, 2025

(54) SYSTEM AND METHOD FOR CONTINUOUS TESTING WITHIN A DEVSECOPS PIPELINE

(71) Applicant: The Toronto-Dominion Bank, Toronto (CA)

(72) Inventors: Yongze DU, Oakville (CA); Babatunde Adeyinka KASSIM, Mississauga (CA); Nandhini SHANKAR, Mississauga (CA); Aayush KATHURIA, Brampton (CA)

(73) Assignee: The Toronto-Dominion Bank, Toronto (CA)

(21) Appl. No.: 18/632,645

(22) Filed: Apr. 11, 2024

(51) Int. Cl. G06F 11/36

(52) U.S. Cl. CPC G06F 11/3688; G06F 11/3698

(57) ABSTRACT

A computer system comprising at least one processor; and a memory coupled to the at least one processor and storing processor-executable instructions which, when executed by the at least one processor, configure the at least one processor to define at least one test automation code base associated with a continuous testing cycle; for the at least one test automation code base, define at least one automated test and criteria associated with the at least one automated test; and map the at least one automated test to a command and parameter to trigger the at least one automated test.

### TECHNICAL FIELD

The present application relates to systems and methods for continuous testing within a DevSecOps pipeline.

### BACKGROUND

Continuous testing within a Development, Security and Operations (DevSecOps) pipeline ensures that code changes are continuously checked for quality, security and functionality as they are integrated into the pipeline.

The continuous testing is not necessarily a true continuous process due to a number of challenges. For example, a large scale or complex application is usually composed of a set of small applications, each of them having their own release cycles. A single test automation code base may contain tests for multiple applications. Only tests related to a specific application release may be required and as such these tests may be triggered manually.

As continuous testing is often triggered manually outside of the DevSecOps pipeline, this may cause significant delays and may result in inefficient usage of computing resources.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computing device;

FIG. 3 shows a simplified organization of software components stored in a memory of the example computing device of FIG. 2;

FIG. 4 is a flowchart showing operations performed by a server computer system in mapping at least one automated test to a command and parameter to trigger the at least one automated test according to an example embodiment; and

FIG. 5 is a flowchart showing operations performed by a server computer system in triggering the at least one automated test according to an example embodiment.

Like reference numerals are used in the drawings to denote like elements and features.

### DETAILED DESCRIPTION OF VARIOUS EMBODIMENTS

Accordingly, in one aspect there is provided a computer system comprising at least one processor; and a memory coupled to the at least one processor and storing processor-executable instructions which, when executed by the at least one processor, configure the at least one processor to define at least one test automation code base associated with a continuous testing cycle; for the at least one test automation code base, define at least one automated test and criteria associated with the at least one automated test; and map the at least one automated test to a command and parameter to trigger the at least one automated test.

In one or more embodiments, the criteria associated with the at least one automated test defines an expected pass rate for the at least one automated test and filter attributes for the at least one automated test.

In one or more embodiments, the processor-executable instructions, when executed by the at least one processor, further configure the at least one processor to determine a condition triggering automation testing with a DevSecOps cycle; and responsive to determining the condition triggering the automation testing within the DevSecOps cycle, initiate the continuous testing cycle.

In one or more embodiments, the condition triggering the automation testing includes determining a code commit associated with computer program code of a particular application.

In one or more embodiments, initiating the continuous testing cycle includes loading the at least one test automation code base.

In one or more embodiments, the condition triggering automation testing within the DevSecOps cycle includes application release information.

In one or more embodiments, the processor-executable instructions, when executed by the at least one processor, further configure the at least one processor to for the at least one test automation code base, identify the at least one automated test by comparing the application release information to the criteria associated with the at least one automated test.

In one or more embodiments, the processor-executable instructions, when executed by the at least one processor, further configure the at least one processor to obtain the command and parameter mapped to the at least one automated test; and automatically trigger execution of the at least one automated test using the obtained command and parameter.

In one or more embodiments, the processor-executable instructions, when executed by the at least one processor, further configure the at least one processor to determine completion of the at least one automated test; and compare a result of the completed at least one automated test to the criteria associated with the at least one automated test to determine whether the completed at least one automated test passed.

In one or more embodiments, the at least one test automation code base includes at least a first test automation code base that defines at least a first automated test and a second test automation code base that defines at least a second automated test, the first automated test and the second automated test being triggered in sequence or parallel.

According to another aspect there is provided a computer-implemented method comprising defining at least one test automation code base associated with a continuous testing cycle; for the at least one test automation code base, define at least one automated test and criteria associated with the at least one automated test; and mapping the at least one automated test to a command and parameter to trigger the at least one automated test.

In one or more embodiments, the criteria associated with the at least one automated test defines an expected pass rate for the at least one automated test and filter attributes for the at least one automated test.

In one or more embodiments, the method further comprises determining a condition triggering automation testing with a DevSecOps cycle; and responsive to determining the condition triggering the automation testing within the DevSecOps cycle, initiating the continuous testing cycle.

In one or more embodiments, initiating the continuous testing cycle includes loading the at least one test automation code base.

In one or more embodiments, the condition triggering automation testing within the DevSecOps cycle includes application release information.

In one or more embodiments, the method further comprises, for the at least one test automation code base, identifying the at least one automated test by comparing the application release information to the criteria associated with the at least one automated test.

In one or more embodiments, the method further comprises obtaining the command and parameter mapped to the at least one automated test; and automatically triggering execution of the at least one automated test using the obtained command and parameter.

In one or more embodiments, the method further comprises determining completion of the at least one automated test; and comparing a result of the completed at least one automated test to the criteria associated with the at least one automated test to determine whether the completed at least one automated test passed.

In one or more embodiments, the at least one test automation code base includes at least a first test automation code base that defines at least a first automated test and a second test automation code base that defines at least a second automated test, the first automated test and the second automated test being triggered in sequence or parallel.

According to another aspect there is provided a non-transitory computer readable medium having stored thereon processor-executable instructions which, when executed by at least one processor, configure the at least one processor to define at least one test automation code base associated with a continuous testing cycle; for the at least one test automation code base, define at least one automated test and criteria associated with the at least one automated test; and map the at least one automated test to a command and parameter to trigger the at least one automated test.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

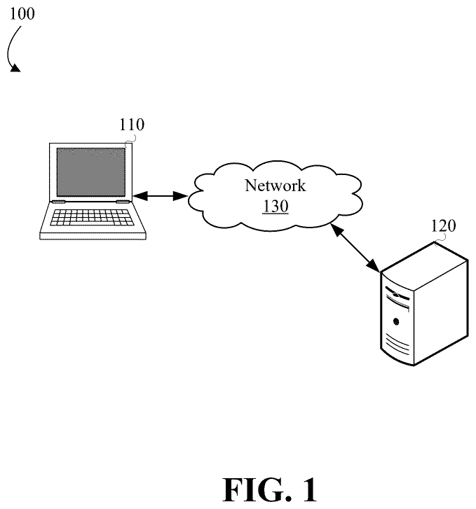

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The computing device 110 may be a laptop computer as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

As will be described in more detail below, the server computer system 120 may be configured to manage continuous testing within a DevSecOps pipeline at least by mapping at least one automated test to a command and parameter to trigger the at least one automated test.

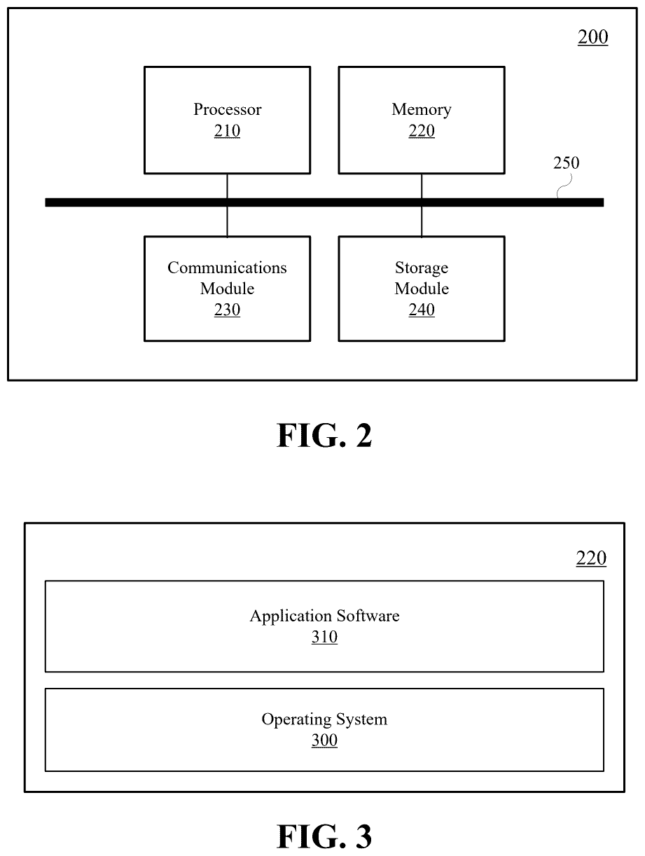

FIG. 2 is a high-level schematic diagram of a computer system 200. The computer system 200 may be any one of the computing device 110 and/or the server computer system 120.

The computer system 200 includes a variety of modules. For example, as illustrated, the computer system 200 may include a processor 210, a memory 220, a communications module 230, and/or a storage module 240. Further, while not illustrated in FIG. 2, the computer system 200 may include an I/O module. As illustrated, the foregoing example modules of the computer system 200 are in communication over a bus 250. As such, the bus 250 may be considered to couple the various modules of the computer system 200 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer system 200.

The communications module 230 allows the computer system 200 to communicate with other computing devices and/or various communications networks such as, for example, the network 130. For example, the communications module 230 may allow the computer system 200 to send or receive communications signals. Communications signals may be sent or received according to one or more protocols or according to one or more standards. The communications module 230 may allow the computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the computer system 200 to communicate using near-field communication (NFC), via Wi-Fi™, using Bluetooth™ or via some combination of one or more networks or protocols. In some embodiments, all or a portion of the communications module 230 may be integrated into a component of the computer system 200. For example, the communications module 230 may be integrated into a communications chipset.

The I/O module is an input/output module. The I/O module allows the computer system 200 to receive input from and/or to provide input to components of the computer system 200 such as, for example, various input modules and output modules. For example, the I/O module may, as shown, allow the computer system 200 to receive input from and/or provide output to a display.

The storage module 240 allows data to be stored and retrieved. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in/from a database when the computer system is operating as the server computer system 120 of FIG. 1. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the computer system 200. As illustrated, these software components include an operating system 300 and an application software 310.

The operating system 300 is software. The operating system 300 allows the application software 310 to access the processor 210 (FIG. 2), the memory 220, the communications module 230, the I/O module, and the storage module 240 of the computer system 200. The operating system 300 may be, for example, Google™ Android™, Apple™ iOS™, UNIX™, Linux™, Microsoft™ Windows™, Apple OSX™ or the like.

The application software 310 adapts the computer system 200, in combination with the operating system 300, to operate as a device for performing a specific function. For example, the application software 310 may cooperate with the operating system 300 to adapt a suitable embodiment of the example computer system 200 to operate as the computing device 110 and/or the server computer system 120.

Continuous testing involves executing automated tests throughout the software delivery pipeline. Continuous testing is performed from development through deployment to provide rapid or real-time feedback on the quality of the software under development.

The continuous testing phase encompasses the integration of testing activities into the continuous integration/continuous delivery (CI/CD) pipeline and this ensures that automated tests are executed at every stage of the development process. The automated tests may include, for example, unit tests, integration tests, end-to-end tests, regression tests, functional tests, smoke tests, security tests, performance tests, usability tests, accessibility tests, and other types of tests that may be performed to verify the correctness, reliability and security of the software.

During the continuous testing phase, automated tests may be triggered whenever code changes are made and this may help to identify or detect defects, regressions, and other issues that may arise. The use of automated tests may help minimize the risk of introducing bugs into the software and accelerate the delivery of reliable and secure software.

The server computer system 120 may manage the continuous testing phase, specifically within a Development, Security and Operations (DevSecOps) pipeline. For example, the server computer system 120 may map at least one automated test to a command and parameter and this may be used to trigger the at least one automated test.

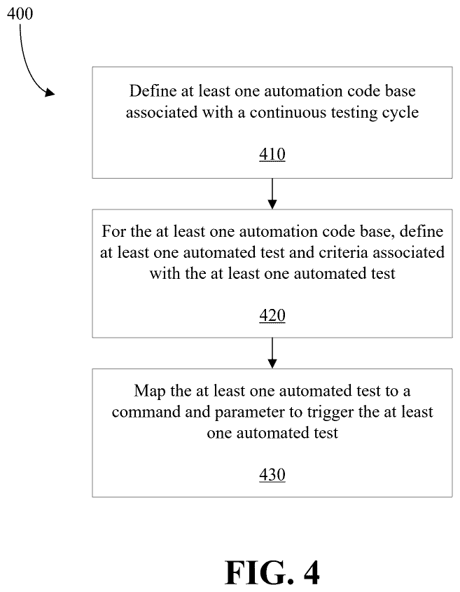

Reference is made to FIG. 4, which illustrates, in flowchart form, a method 400 for mapping at least one automated test to a command and parameter to trigger the at least one automated test. The method 400 may be implemented by a computing device having suitable processor-executable instructions for causing the computing device to carry out the described operations. The method 400 may be implemented, in whole or in part, by the server computer system 120.

The method 400 includes defining at least one test automation code base associated with a continuous testing cycle (step 410).

The at least one test automation code base may be referred to as at least one test automation repository. The at least one test automation code base includes a collection of code, scripts, configurations and resources that are used to implement and maintain automated tests within a software development cycle. The at least one automation code base may facilitate creation, execution, and management of automated test cases.

The at least one test automation code base may be provided in the form of processor-executable instructions that define or otherwise inform the DevOps pipeline of a list of test automation code bases which may be used in a continuous testing cycle. The instructions may be stored in a data file such as for example a YAML Ain′t Markup Language (*.yml) file. It will be appreciated that the instructions may enable execution of multiple test automation code bases for the same application release.

The method 400 includes for the at least one test automation code base, defining at least one automated test and criteria associated with the at least one automated test (step 420).

In one or more embodiments, for each test automation code base, processor-executable instructions may be defined or otherwise provided. The processor-executable instructions may define the at least one automated test and criteria associated with the at least one automated test

The at least one automated test may be in the form of a test scrip that includes scripts or code snippets written in a programming language such as for example Java™, Pyton™, JavaScript™. The scripts or code snippets define steps to be executed to automate the testing of various aspects of an application. The at least one automated test may include, for example, a unit test, an integration test, an end-to-end test, a regression test, a functional test, a smoke test, a security test, a performance test, a usability test, an accessibility test, etc.

In one or more embodiments, the at least one automated test may be defined or identified using a test name. The test name may be unique to the application, environment or specific application function or value. For example, the test name of the at least one automated test may be unique to the application that is to be tested using the at least one automated test.

In one or more embodiments, the at least one automated test may be preconfigured or may otherwise be a predefined automated test that may be included with the at least one test automation code base. The preconfigured or predefined automated test may defined within the at least one test automation code base using a test name.

In one or more embodiments, the criteria associated with the at least one automated test may include an expected pass rate for the at least one automated test and filter attributes for the at least one automated test. The expected pass rate may define a threshold that may be used to determine whether or not the at least one automated test has passed.

The filter attributes for the at least one automated test may define criteria that may be used to determine if the at least one automated test is valid for a current release based on information of the release application code, the target environment, or the release application value or function.

The method 400 includes mapping the at least one automated test to a command and parameter to trigger the at least one automated test (step 430).

The at least one automated test is mapped to a command and parameter that may be used to trigger the at least one automated test. The command may include a line of text or script that may be entered into a command-line interface or other type of automation deployment tool. The command may serve as an entry point for starting the automation testing process using the at least one automated test. The parameter may be used to provide additional information or configurations that modify the behavior of the at least one automated test. The parameter may include a location of the at least one automated test, a location of test scripts associated with the at least one automated test, the type of tests to run, the target environment for testing, etc.

In one or more embodiments, it may be the test name of the at least one automated test that is mapped to the command and parameter.

The mapping between the at least one automated test and the command and parameter to trigger the at least one automated test may be stored in a database associated with the server computer system 120. For example, the mapping may be stored in the database in the form of a lookup table where the database may be consulted to look up the at least one automated test to automatically retrieve the command and parameter that may be used to trigger the at least one automated test.

The command and parameter may be used to automatically trigger the automated testing using the at least one automated test. Put another way, by mapping the at least one automated test to the command and parameter to trigger the at least one automated test, each automated test may be automatically triggered on-demand.

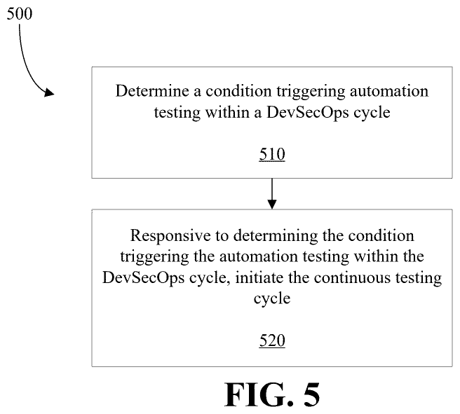

The server computer system 120 may utilize the mapping between the at least one automated test to the command and parameter to trigger the at least one automated test. Reference is made to FIG. 5, which illustrates, in flowchart form, a method 500 for triggering the at least one automated test. The method 500 may be implemented by a computing device having suitable processor-executable instructions for causing the computing device to carry out the described operations. The method 500 may be implemented, in whole or in part, by the server computer system 120.

The method 500 includes determining a condition triggering automation testing within a DevSecOps cycle (step 510).

The condition triggering automation testing may be based on changes made to computer program code of one or more applications. For example, the server computer system 120 may monitor a code repository which may be a centralized storage location for source files and related files for one or more applications.

In one or more embodiments, the condition triggering the automation testing may include determining a code commit associated with computer program code of a particular application. For example, a computer programmer may modify or otherwise update the computer program code of the particular application. Once the modification or updating is complete, modified or updated computer program code may be submitted to the code repository. This may require adding, modifying or deleting files within the code repository. It will be appreciated that the server computer system 120 may maintain records of the changes and this may be done to maintain a history of changes or updates to computer program code of the particular application.

In one or more embodiments, the server computer system 120 may engage a third party server that may be associated with a control service for managing code commits and the server may communicate with the third party server to determine the condition triggering automation testing. Examples may include GitHub™, Amazon™ CodeCommit, GitLab™, etc.

It will be appreciated that the condition triggering automation testing may include additional information relating to the code commit. For example, the condition triggering automation testing may include application release information such as for example the release application code, target environment, release application value or function, etc.

The method 500 includes responsive to determining the condition triggering the automation testing within the DevSecOps cycle, initiate the continuous testing cycle (step 520).

As mentioned, in one or more embodiments, the condition triggering the automation testing may include determining a code commit associated with computer program code of a particular application. As such, responsive to determining the code commit associated with computer program code of the particular application, the server computer system 120 may initiate a continuous testing cycle.

In one or more embodiments, initiating the continuous testing cycle may include loading the at least one test automation code base. For example, the server computer system 120 may load the at least one test automation code base associated with the continuous testing cycle that was generated during the step 410 of the method 400 and this may be done responsive to determining the condition triggering the automation testing. It will be appreciated that multiple test automation code bases may be loaded.

Once the at least one test automation code base has been loaded, the server computer system 120 may wait until continuous integration and continuous delivery (CI/CD) pipeline has been completed.

Once the CI/CD pipeline has been completed, the server computer system 120 may verify that the at least one test automation code base is available. Once verified, the server computer system 120 may determine at least one automated test within the at least one test automation code base that is to be performed or executed within the continuous testing cycle.

As mentioned, in one or more embodiments, the condition triggering automation testing may include application release information. In these embodiments, the server computer system 120 may use the application release information to identify the at least one automated test to be performed or executed. Specifically, the server computer system 120 may compare the application release information to the criteria associated with the at least one automated test. For example, as mentioned, the criteria associated with the at least one automated test may include filter attributes that define criteria that may be used to determine if the at least one automated test is valid for a current release based on information of the release application code, the target environment, or the release application value or function. As such, the application release information may be compared to the filter attributes to identify the at least one automated test. It will be appreciated that the server computer system 120 may identify more than one automated test from one or more test automation code bases. The automated tests may be identified using, for example, test name and the server computer system 120 may generate a list of all automated tests to be performed within the continuous testing cycle where each automated test is identified using the associated test name.

Once all automated tests from all test automation code bases have been identified using the application release information, the server computer system 120 may initiate execution of the continuous testing cycle and this may be done as an independent phase within the DevSecOps pipeline.

Execution of the continuous testing cycle may include performing all automated tests identified using the application release information. The automated tests may be triggered or otherwise performed in sequence or parallel. For example, the at least one automated code base may include at least a first test automation code base that defines at least a first automated test and a second test automation code base that defines at least a second automated test. The first automated test and the second automated test may be being triggered in sequence or parallel.

To perform each test, the server computer system 120 may obtain the command and parameter mapped to the at least one automated test. For example, the server computer system 120 may perform a lookup using the test name of the automated test to determine the command and parameter mapped to the automated test. The server computer system 120 then triggers the execution of the automated test using the command and parameter associated therewith.

After the at least one test is completed, the server computer system 120 may analyze results of the test to determine whether or not the at least one test passed. For example, as mentioned, the criteria associated with the at least one automated test may include an expected pass rate for the at least one automated test, where the expected pass rate may define a threshold that may be used to determine whether or not the at least one automated test has passed. As such, the server computer system 120 may compare a result of the at least one automated test to the threshold to determine whether the completed at least one automated test passed. For example, if the pass rate of the at least one automated test is equal to or greater than the threshold, the at least one automated test may be considered to have passed.

The server computer system 120 may determine that all of the automated tests have passed and as such the continuous testing cycle is considered a pass and the DevSecOps pipeline may move to a next phase.

Of course, the server computer system 120 may determine that one or more of the automated tests have failed and as such the continuous testing cycle may be considered a failure. As a result, the server computer system 120 may pause or otherwise halt DevSecOps pipeline and may mark the continuous testing cycle as failed.

In embodiments described herein, mapping at least one automated test to a command and parameter to trigger the at least one automated test, the continuous testing cycle is fully automated and truly continuous. This eliminates the requirement to manually trigger automated tests within a DevSecOps pipeline. Further, by defining criteria such as for example an expected pass rate and filter attributes, application release information may be used to automatically identify what automated tests are to be performed for a particular application. This reduces the reliance on computing resources as automated tests that are not required are not performed.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
at least one processor; and
a memory coupled to the at least one processor and storing processor-executable instructions which, when executed by the at least one processor, configure the at least one processor to:
define at least one test automation code base associated with a continuous testing cycle;
for the at least one test automation code base, define at least one automated test and criteria associated with the at least one automated test; and
map the at least one automated test to a command and parameter to trigger the at least one automated test.

2. The computer system of claim 1, wherein the criteria associated with the at least one automated test defines an expected pass rate for the at least one automated test and filter attributes for the at least one automated test.

3. The computer system of claim 1, wherein the processor-executable instructions, when executed by the at least one processor, further configure the at least one processor to:
determine a condition triggering automation testing with a DevSecOps cycle; and
responsive to determining the condition triggering the automation testing within the DevSecOps cycle, initiate the continuous testing cycle.

4. The computer system of claim 3, wherein the condition triggering the automation testing includes determining a code commit associated with computer program code of a particular application.

5. The computer system of claim 3, wherein initiating the continuous testing cycle includes loading the at least one test automation code base.

6. The computer system of claim 5, wherein the condition triggering automation testing within the DevSecOps cycle includes application release information.

7. The computer system of claim 6, wherein the processor-executable instructions, when executed by the at least one processor, further configure the at least one processor to:
for the at least one test automation code base, identify the at least one automated test by comparing the application release information to the criteria associated with the at least one automated test.

8. The computer system of claim 7, wherein the processor-executable instructions, when executed by the at least one processor, further configure the at least one processor to:
obtain the command and parameter mapped to the at least one automated test; and
automatically trigger execution of the at least one automated test using the obtained command and parameter.

9. The computer system of claim 8, wherein the processor-executable instructions, when executed by the at least one processor, further configure the at least one processor to:
determine completion of the at least one automated test; and
compare a result of the completed at least one automated test to the criteria associated with the at least one automated test to determine whether the completed at least one automated test passed.

10. The computer system of claim 1, wherein the at least one test automation code base includes at least a first test automation code base that defines at least a first automated test and a second test automation code base that defines at least a second automated test, the first automated test and the second automated test being triggered in sequence or parallel.

11. A computer-implemented method comprising:
defining at least one test automation code base associated with a continuous testing cycle;
for the at least one test automation code base, define at least one automated test and criteria associated with the at least one automated test; and
mapping the at least one automated test to a command and parameter to trigger the at least one automated test.

12. The method of claim 11, wherein the criteria associated with the at least one automated test defines an expected pass rate for the at least one automated test and filter attributes for the at least one automated test.

13. The method of claim 11, further comprising:
determining a condition triggering automation testing with a DevSecOps cycle; and
responsive to determining the condition triggering the automation testing within the DevSecOps cycle, initiating the continuous testing cycle.

14. The method of claim 13, wherein initiating the continuous testing cycle includes loading the at least one test automation code base.

15. The method of claim 14, wherein the condition triggering automation testing within the DevSecOps cycle includes application release information.

16. The method of claim 15, further comprising:
for the at least one test automation code base, identifying the at least one automated test by comparing the application release information to the criteria associated with the at least one automated test.

17. The method of claim 16, further comprising:
obtaining the command and parameter mapped to the at least one automated test; and
automatically triggering execution of the at least one automated test using the obtained command and parameter.

18. The method of claim 17, further comprising:
determining completion of the at least one automated test; and
comparing a result of the completed at least one automated test to the criteria associated with the at least one automated test to determine whether the completed at least one automated test passed.

19. The method of claim 11, wherein the at least one test automation code base includes at least a first test automation code base that defines at least a first automated test and a second test automation code base that defines at least a second automated test, the first automated test and the second automated test being triggered in sequence or parallel.

20. A non-transitory computer readable medium having stored thereon processor-executable instructions which, when executed by at least one processor, configure the at least one processor to:
define at least one test automation code base associated with a continuous testing cycle;
for the at least one test automation code base, define at least one automated test and criteria associated with the at least one automated test; and
map the at least one automated test to a command and parameter to trigger the at least one automated test.
